(19) United States
(12) Patent Application Publication
(10) Pub. No.: US 2016/0072649 A1
(43) Pub. Date: Mar. 10, 2016

(54) Methods and Systems for Minimum Mean Squares Based Non-Linear Interference Management in Multi-Technology Communication Devices

(71) Applicant: QUALCOMM Incorporated, San Diego, CA (US)

(72) Inventors: Sheng-Yuan TU, San Diego, CA (US); Farrokh Abrishamkar, San Diego, CA (US); Brian Clarke Banister, San Diego, CA (US); Roberto Rimini, San Diego, CA (US); lnsung Kang, San Diego, CA (US); Taesang Yoo, Riverside, CA (US)

(21) Appl. No.: 14/849,563

(22) Filed: Sep. 9, 2015

Related U.S. Application Data
(60) Provisional application No. 62/048,519, filed on Sep. 10, 2014.

(51) Int. Cl. H04L 25/03; H04B 1/7107

(52) U.S. Cl. CPC H04L 25/03159; H04B 1/7107

(57) ABSTRACT

The various embodiments include methods and apparatuses for cancelling nonlinear interference during concurrent communication of multi-technology wireless communication devices. Nonlinear interference may be estimated using a minimum mean squares interference filter by generating aggressor kernels from the aggressor signals, augmenting the aggressor kernels by weight factors and executing a linear combination of the augmented output, at an intermediate layer to produce intermediate layer outputs. At an output layer, a linear filter function may be executed on the intermediate layer outputs to produce an estimated nonlinear interference used to cancel the nonlinear interference of a victim signal.

### RELATED APPLICATIONS

This application claims the benefit of priority under 35 U.S.C. §119(e) of U.S. Provisional Application No. 62/048,519 entitled “Multilayer Perceptron For Dual SIM Dual Active Interference Cancellation” filed Sep. 10, 2014, the entire contents of which are hereby incorporated by reference.

### BACKGROUND

Some wireless communication devices—such as smart phones, tablet computers, laptop computers, and routers—contain hardware and/or software elements that provide access to multiple wireless communication networks simultaneously. For example, a wireless communication device can have one or more radio frequency communication circuits (or “RF chains”) for accessing one or more wireless local area networks (“WLANs”), wireless wide area networks (“WWANs”), and/or global positioning systems (“GPS”). When multiple reception (“Rx”) and/or transmission (“Tx”) operations are implemented simultaneously, i.e., co-exist, on a wireless communication device, these operations may interfere with each other.

### SUMMARY

The methods and apparatuses of various embodiments provide circuits and methods for managing interference in a multi-technology communication device. Embodiment methods may include receiving an aggressor signal at an input layer of a minimum mean squares interference filter, generating a set of minimum mean squares (MMS) kernels, augmenting the MMS kernels with weight factors at an intermediate layer of the minimum mean squares interference filter to produce augmented MMS kernels, linearly combining the augmented MMS kernels at the intermediate layer to produce an intermediate layer output, and executing a linear filter function on the intermediate layer outputs at an output layer of the minimum mean squares interference filter to obtain estimated nonlinear interference.

Some embodiments may further include determining an error of the estimated nonlinear interference, determining whether the error of the estimated nonlinear interference exceeds an efficiency threshold, and cancelling the estimated nonlinear interference from a victim signal. Such embodiments may further include training the weight factors to reduce an error of the estimated nonlinear interference. In such embodiments, training the weight factors to reduce an error of the estimated nonlinear interference may include training weight factors in response to determining that the error of the estimated nonlinear interference exceeds the efficiency threshold. In such embodiments, cancelling the estimated nonlinear interference from the victim signal may include cancelling the estimated nonlinear interference from the victim signal in response to determining that the error of the estimated nonlinear interference does not exceed the efficiency threshold. Alternatively, such embodiments may further include training the weight factors using a three stage minimum mean squares method.

Some embodiments may further include estimating an initial value of the weight factors using a three stage minimum mean squares method. In some embodiments, the linear filter function may be a finite impulse response filter. In some embodiments, the linear filter function may have a Hammerstein structure. In some embodiments, the received aggressor signal may represent an aggressor signal received by an antenna of the multi-technology communication device.

In some embodiments, generating a set of MMS kernels may further include executing a kernel function of a pre-determined order on the aggressor signal to obtain MMS kernels. Such embodiments may further include executing the first kernel function of pre-determined order from order 1 to order “p”.

Some embodiments may include cancelling the estimated nonlinear interference from a victim signal received by an antenna. Such embodiments may further include decoding the victim signal after cancelling the estimated nonlinear interference from the victim signal. Some embodiments may include training a second set of weights is trained using a three-stage minimum mean squares method.

Some embodiment methods may include receiving an aggressor signal at an input layer of a minimum mean squares interference filter, generating a set of minimum mean squares (MMS) kernels, executing a linear filter function on the MMS kernels at an output layer of the minimum mean squares interference filter to obtain estimated nonlinear interference. Some embodiments may include determining an error of the estimated nonlinear interference, determining whether the error of the estimated nonlinear interference exceeds an efficiency threshold, and cancelling the estimated nonlinear interference from a victim signal received by the antenna. In such embodiments, executing a linear filter function on the MMS kernels at an output layer of the minimum mean squares interference filter may include executing a separate sampling delay line on each of the MMS kernels, augmenting the sampled MMS kernels, and linearly combining the sampled MMS kernels to produce an estimated nonlinear interference. In such embodiments, the linear filter function may be a finite impulse response filter. In such embodiments, the linear filter function may have a Hammerstein structure. In such embodiments, the received aggressor signal may represent an aggressor signal received by an antenna of the multi-technology communication device at a specific instance in time. In such embodiments, generating a set of MMS kernels may include executing a kernel function of a pre-determined order on the aggressor signal to obtain MMS kernels. Such embodiments may include executing the first kernel function of pre-determined order from order 1 to order “p”. Such embodiments may include cancelling the estimated nonlinear interference from a victim signal received by an antenna. Such embodiments may further include decoding the victim signal after cancelling the estimated nonlinear interference from the victim signal.

Some embodiment methods may include receiving an aggressor signal at a minimum mean squares interference filter, generating a set of minimum mean squares kernels (MMS kernels) from the aggressor signal, and calculating an estimated linear interference signal based on the aggressor signal using the MMS kernels, the calculating including executing a linear filter function to obtain the estimated nonlinear interference. In some embodiments, the method may further include augmenting the set of MMS kernels with weight factors at an intermediate layer of the minimum mean squares interference filter to produce augmented MMS kernels, linearly combining the augmented MMS kernels at the intermediate layer to produce an intermediate layer output, and executing the linear filter function on the intermediate layer output to obtain the estimated nonlinear interference.

Embodiments include a multi-technology communication device having an antenna configured to receive an aggressor signal at the multi-technology communication device, and a processor communicatively connected to the antenna and configured with processor-executable instructions to perform operations of one or more of the embodiment methods described above.

Embodiments include a multi-technology communication device having means for performing functions of one or more of the embodiment methods described above.

Embodiments include a non-transitory processor-readable medium having stored thereon processor-executable software instructions to cause a processor to perform operations of one or more of the embodiment methods described above.

### BRIEF DESCRIPTION OF THE DRAWINGS

The accompanying drawings, which are incorporated herein and constitute part of this specification, illustrate exemplary embodiments of the claims, and together with the general description given above and the detailed description given below, serve to explain the features of the claims.

FIG. 1 is a communication system block diagram illustrating a network suitable for use with various embodiments.

FIG. 2 is a component block diagram illustrating various embodiments of a multi-technology wireless communications device.

FIG. 3 is a component block diagram illustrating an interaction between components of different transmit/receive chains in various embodiments of a multi-technology wireless communications device.

FIG. 4 is a component block diagram illustrating a minimum mean squares interference filter for interference cancellation in accordance with various embodiments.

FIGS. 5A-5B are component block diagrams illustrating layers of a minimum mean squares interference filter for interference cancellation in accordance with various embodiments.

FIGS. 6A-C are functional block diagrams illustrating interaction between components of a minimum mean squares interference filter for interference cancellation in accordance with various embodiments.

FIG. 7 is a process flow diagram illustrating a method for canceling nonlinear interference using a minimum mean squares interference filter in various embodiments of a multi-technology wireless communications device in accordance with various embodiments.

FIGS. 8A-B are process flow diagrams illustrating methods for estimating nonlinear interference using a minimum mean squares interference filter in a multi-technology wireless communications device in accordance with various embodiments.

FIG. 9 is a process flow diagram illustrating a method for training weight factors for use in a minimum mean squares interference filter in a multi-technology wireless communications device in accordance with various embodiments.

FIG. 10 is a component diagram of an example multi-technology wireless communication device suitable for use with various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

The word “exemplary” is used herein to mean “serving as an example, instance, or illustration.” Any implementation described herein as “exemplary” is not necessarily to be construed as preferred or advantageous over other implementations.

The terms “computing device,” “mobile device,” and “wireless communication device” are used interchangeably herein to refer to any one or all of cellular telephones, smartphones, personal or mobile multi-media players, personal data assistants (PDAs), laptop computers, tablet computers, smartbooks, ultrabooks, palm-top computers, wireless electronic mail receivers, multimedia Internet enabled cellular telephones, wireless gaming controllers, and similar personal electronic devices which include a memory, a programmable processor and wireless communication circuitry. As used herein, the terms “multi-technology communication device” and “multi-technology communication device” refer to a wireless communication device that supports access to at least two mobile communication networks. While the various embodiments are particularly useful for mobile devices, such as smartphones, the embodiments are generally useful in any electronic device that implements radio hardware in close proximity to other hardware.

Descriptions of the various embodiments refer to multi-technology communication devices for exemplary purposes. However, the embodiments may be suitable for any multiple-technology (multi-technology) wireless communication device that may individually maintain a plurality of connections to a plurality of mobile networks through one or more radio communication circuits. For example, the various embodiments may be implemented in multi-SIM multi-active devices of any combination of number of subscriber identity modules (SIM) and concurrently active subscriptions. Moreover, a SIM may not be required for a wireless communication device to implement the various embodiments, which may apply to any form of wireless communication.

In a wireless communication device with multiple RF chains, the antennas of the RF chains may be in close proximity to each other. This close proximity may cause one RF chain to desensitize or interfere with the ability of another during the simultaneous use of the RF chains. Receiver desensitization (“desense”), or degradation of receiver sensitivity, may result from noise interference of a nearby transmitter. In particular, when two radios are close together with one transmitting on the uplink (the “aggressor”) and the other receiving on the downlink (the “victim”), signals from the transmitter may be picked up by the receiver or otherwise interfere with reception of a weaker signal (e.g., from a distant base station). As a result, the received signals may become corrupted and difficult or impossible for the victim to decode. In particular, desense of received signals presents a design and operational challenge for multi-radio devices due to the proximity of transmitter and receiver.

Multi-technology devices enable a user to connect to different mobile networks (or different accounts on the same network) while using the same multi-technology communication device. For example, a multi-technology communication device may connect to GSM, TDSCDMA, CDMA2000, WCDMA and other radio frequency networks. In the various embodiments, multi-technology communication devices may also include two RF chains so that each network communication supported by each RF chain can be accomplished concurrently.

However, multi-technology devices can suffer from interference between two communications being accomplished concurrently, such as when one communication session is transmitting (“Tx”) at the same time as another communication session is attempting to receive (“Rx”). As used herein, the term “victim” refers to the communication service or subscription suffering from interference at a given instant, and the term “aggressor” refers to the communication service or subscription whose Rx or Tx actions are causing the interference. In an example multi-technology communication device, the victim may be attempting to receive RF signals from a network while the aggressor attempts to transmit RF signals to another network. In an example of such interference, an aggressor's transmissions may de-sense the victim's reception, in which case the victim may receive the aggressor's transmissions that act as noise and interfere with the victim's ability to receive wanted RF signals.

In multi-technology communication devices, an aggressor's transmissions may cause severe impairment to the victim's ability to receive transmission. This interference may be in the form of blocking interference, harmonics, intermodulation, or other noises and distortion. Such interference may significantly degrade the victim's receiver sensitivity, link to a network, voice call quality and data throughput. These effects may result in a reduced network capacity for the affected communication service or subscription. The aggressor's transmission may also cause receiver sensitivity of the victim signal that is drastically degraded, resulting in call quality degradation, higher rates for call drops and radio link failures, and data throughput degradation, which may potentially cause the victim to lose a data connection.

Nonlinear signals of the RF chains may be to blame for desense of received signals. Often the Tx/aggressor signal frequency is a fraction of the Rx/victim signal frequency. However, multiple aggressor signals may constructively combine to form a harmonic aggressor signal to the victim signal. The harmonic aggressor signal may be strong enough to cause nonlinear interference of the victim signal.

In order to recover information from the victim signal, various circuits and processing methods may be used to remove or subtract the interfering signals from the received victim signal. However, removing or subtracting nonlinear interference from a victim signal is particularly problematic for devices having multiple RF chain, such as multi-SIM multi-active (“MSMA”) devices and for Long-Term Evolution (“LTE”) carrier aggregation, because interference experienced on one RF chain may come from multiple RF sources and thus may have unpredictable signal form. Current techniques for removing nonlinear interference from a victim signal are case specific, requiring the communications device to have knowledge of the communication technology used for the transmission and reception of signals, and the kind of interference the aggressor signal is causing.

The various embodiments include methods for removing nonlinear interference from a victim signal in digital communications by using an interference filter analysis method to estimate the coefficients of the signal to be removed before a received signal is decoded. In particular, the interference filter may implement supervised learning using minimum mean squares methods with a linear filter to dynamically estimate an interference of the aggressor signals on the victim signal to be removed from the victim signal so that it may be decoded. An absolute calculation of the nonlinear interference may be mathematically difficult. Accordingly, the various embodiments provide methods that may be implemented in cost effective circuits and processing algorithms to provide an effective estimate of the interference, which when subtracted from the victim signal results in significant improvement in the recovered signal.

In various embodiments, a mobile device may use the interference filter method combined with a linear filter function to estimate a function of the nonlinear interference from a set of known aggressor reference signals and a victim reference signal without having to know the type of communication technology or type, source or form of interference. The set of aggressor reference signals may be obtained from the RF chain on the mobile device supporting the aggressor reference signals. The victim reference signal may be obtained from the RF chain on the mobile device supporting the victim reference signal. These known signals may be received by the minimum mean squares interference filter at an input layer. The aggressor reference signals may be used to generate multiple MMS aggressor kernels, which may be placed in an MMS aggressor kernel matrix. The MMS aggressor kernel matrix may be received by the interference filter at an input layer in place of the aggressor reference signals. From the input layer the interference filter may pass the MMS aggressor kernels, such as by matrix rows and/or as individual kernels, to an intermediate layer of the interference filter. In passing these MMS aggressor kernels to the intermediate layer, the MMS aggressor kernels may be combined and augmented using weight factors. The augmented MMS aggressor kernels may be linearly combined. An output of the intermediate layer may be passed to an output layer. All of the outputs of the intermediate layer may again be augmented by a second set of weight factors and linearly combined. An output of the output layer may be an estimation of a jammer signal distorting the victim signal an estimated nonlinear interference, from which a function of the nonlinear interference may be determined. The estimated nonlinear interference may then be removed from a received victim signal.

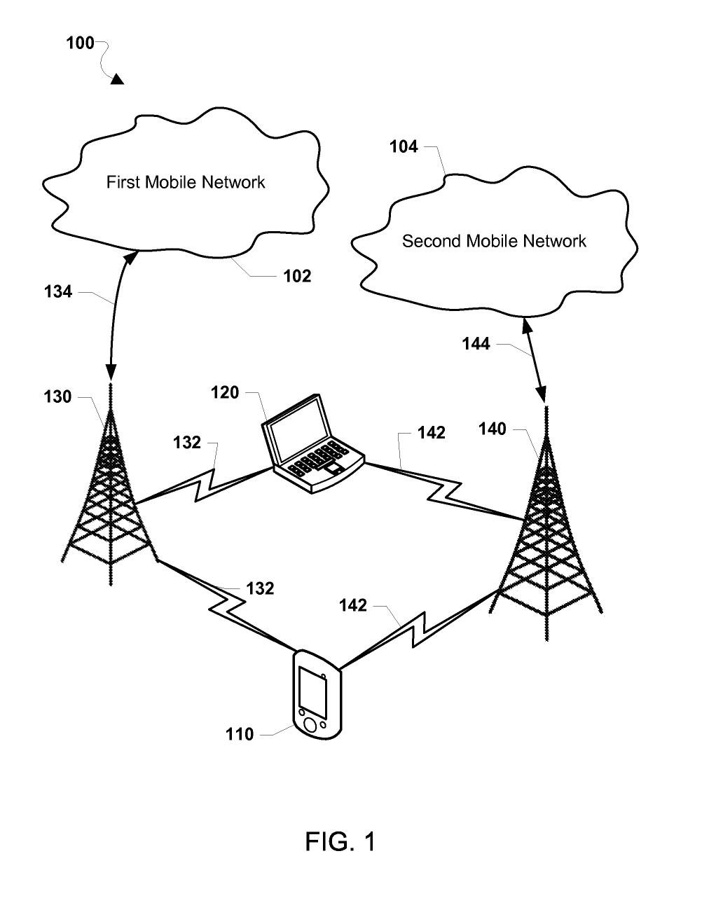

The various embodiments may be implemented in wireless communication devices that operate within a variety of communication systems 100, such as at least two mobile telephony networks, an example of which is illustrated in FIG. 1. A first mobile network 102 and a second mobile network 104 are typical mobile networks that include a plurality of cellular base stations 130 and 140. A first multi-technology communication device 110 may be in communication with the first mobile network 102 through a cellular connection 132 to a first base station 130. The first multi-technology communication device 110 may also be in communication with the second mobile network 104 through a cellular connection 142 to a second base station 140. The first base station 130 may be in communication with the first mobile network 102 over a connection 134. The second base station 140 may be in communication with the second mobile network 104 over a connection 144.

A second multi-technology communication device 120 may similarly communicate with the first mobile network 102 through a radio based communication connection such as a cellular connection 132 to a first base station 130. The second multi-technology communication device 120 may communicate with the second mobile network 104 through a radio communication connection such as a cellular connection 142 to the second base station 140. Cellular connections 132 and 142 may be made through two-way wireless communication links, such as 4G, 3G, CDMA, TDSCDMA, WCDMA, GSM, and other mobile telephony communication technologies. Other radio communication connections may include various other wireless connections, including WLANs, such as Wi-Fi based on IEEE 802.11 standards, and wireless location services, such as GPS. For example, the first wireless communications device may transmit and receive WiFi communications from a network resource such as a router. Similarly, the wireless communications device may transmit and receive wireless communications with multiple Bluetooth enabled devices such as peripheral devices (e.g., keyboards, speakers, displays) as well as the second wireless communications device. The transmission and receipt of wireless communications over any and all of these radio resources may result in desense on victim signals during overlapping periods of transmission.

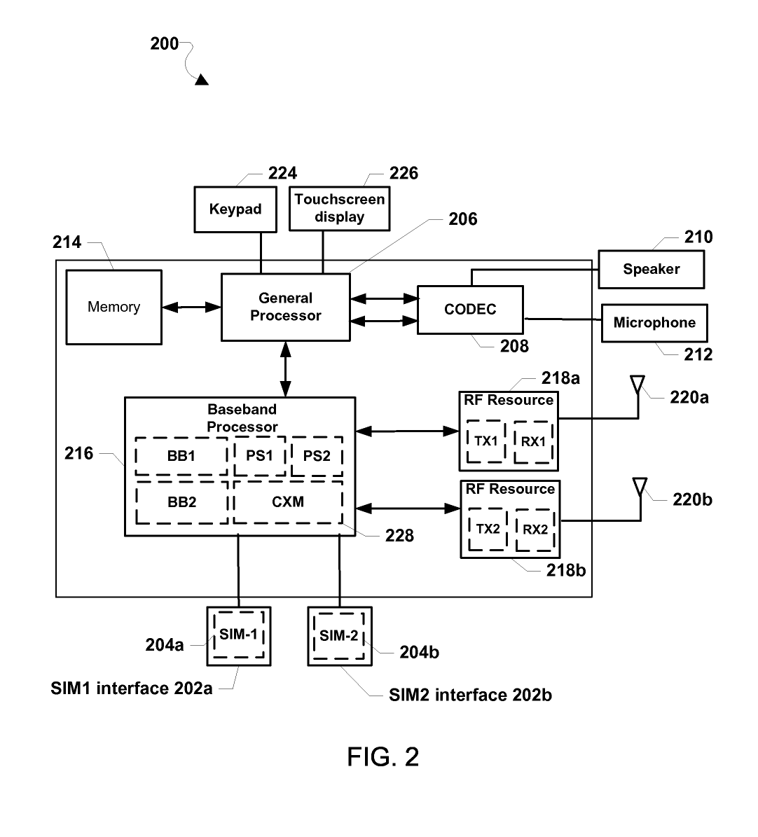

FIG. 2 illustrates various embodiments of a multi-technology communication device 200 (e.g., 110, 120 in FIG. 1) that are suitable for implementing the various embodiments. With reference to FIGS. 1 and 2, the multi-technology communication device 200 may include a first SIM interface 202a, which may receive a first identity module SIM-1 204a that is associated with a first subscription. The multi-technology communication device 200 may also include a second SIM interface 202b, which may receive a second identity module SIM-2 204b that is associated with a second subscription.

A SIM in the various embodiments may be a Universal Integrated Circuit Card (UICC) that is configured with SIM and/or USIM applications, enabling access to, for example, GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card.

Each SIM may have a CPU, ROM, RAM, EEPROM and I/O circuits. A SIM used in the various embodiments may contain user account information, an international mobile subscriber identity (IMSI), a set of SIM application toolkit (SAT) commands and storage space for phone book contacts. A SIM may further store a Home Public-Land-Mobile-Network (HPLMN) code to indicate the SIM card network operator provider. An Integrated Circuit Card Identity (ICCID) SIM serial number may be printed on the SIM for identification.

Each multi-technology communication device 200 may include at least one controller, such as a general purpose processor 206, which may be coupled to a coder/decoder (CODEC) 208. The CODEC 208 may in turn be coupled to a speaker 210 and a microphone 212. The general purpose processor 206 may also be coupled to at least one memory 214. The memory 214 may be a non-transitory tangible computer readable storage medium that stores processor-executable instructions. For example, the instructions may include routing communication data relating to the first or second subscription though a corresponding baseband-RF resource chain.

The memory 214 may store operating system (OS), as well as user application software and executable instructions. The memory 214 may also store application data, such as an array data structure.

The general purpose processor 206 and memory 214 may each be coupled to at least one baseband modem processor 216. Each SIM in the multi-technology communication device 200 (e.g., SIM-1 202a and SIM-2 202b) may be associated with a baseband-RF resource chain. Each baseband-RF resource chain may include the baseband modem processor 216 to perform baseband/modem functions for communications on a SIM, and one or more amplifiers and radios, referred to generally herein as RF resources 218a, 218b. In some embodiments, baseband-RF resource chains may interact with a shared baseband modem processor 216 (i.e., a single device that performs baseband/modem functions for all SIMs on the wireless device). Alternatively, each baseband-RF resource chain may include physically or logically separate baseband processors (e.g., BB1, BB2).

In some embodiments, the baseband modem processor 216 may be an integrated chip capable of managing the protocol stacks of each of the SIMs or subscriptions (e.g., PS1, PS1) and implementing a co-existence manager software 228 (e.g., CXM). By implementing modem software, subscription protocol stacks, and the co-existence manager software 228 on this integrated baseband modem processor 216, thread based instructions may be used on the integrated baseband modem processor 216 to communicate instructions between the software implementing the interference prediction, the mitigation techniques for co-existence issues, and the Rx and Tx operations.

The RF resources 218a, 218b may be communication circuits or transceivers that perform transmit/receive functions for the associated SIM of the wireless device. The RF resources 218a, 218b may be communication circuits that include separate transmit and receive circuitry, or may include a transceiver that combines transmitter and receiver functions. The RF resources 218a, 218b may be coupled to a wireless antenna (e.g., a first wireless antenna 220a and a second wireless antenna 220b). The RF resources 218a, 218b may also be coupled to the baseband modem processor 216.

In some embodiments, the general purpose processor 206, memory 214, baseband processor(s) 216, and RF resources 218a, 218b may be included in the multi-technology communication device 200 as a system-on-chip. In other embodiments, the first and second SIMs 202a, 202b and their corresponding interfaces 204a, 204b may be external to the system-on-chip. Further, various input and output devices may be coupled to components on the system-on-chip, such as interfaces or controllers. Example user input components suitable for use in the multi-technology communication device 200 may include, but are not limited to, a keypad 224 and a touchscreen display 226.

In some embodiments, the keypad 224, touchscreen display 226, microphone 212, or a combination thereof, may perform the function of receiving the request to initiate an outgoing call. For example, the touchscreen display 226 may receive a selection of a contact from a contact list or receive a telephone number. In another example, either or both of the touchscreen display 226 and microphone 212 may perform the function of receiving a request to initiate an outgoing call. For example, the touchscreen display 226 may receive a selection of a contact from a contact list or receive a telephone number. As another example, the request to initiate the outgoing call may be in the form of a voice command received via the microphone 212. Interfaces may be provided between the various software modules and functions in multi-technology communication device 200 to enable communication between them, as is known in the art.

In some embodiments, the multi-technology communication device 200 may instead be a single-technology or multiple-technology device having more or less than two RF chains. Further, various embodiments may implement, single RF chain or multiple RF chain wireless communication devices with fewer SIM cards than the number of RF chains, including without using any SIM card.

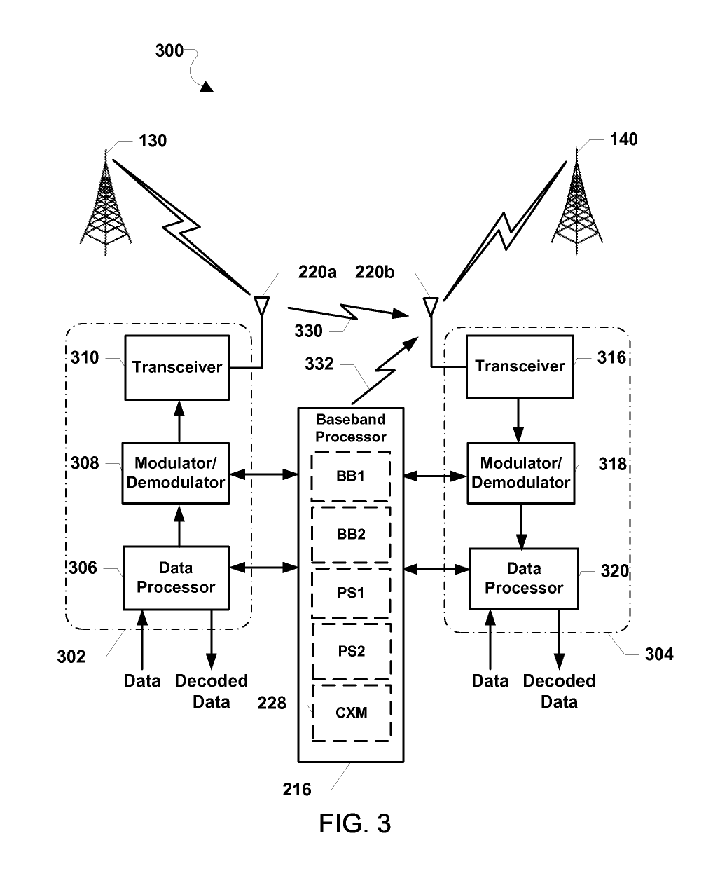

FIG. 3 is a block diagram of a communication system 300 that illustrates embodiment interactions between components of different transmit/receive chains in a multi-technology wireless communications device. With reference to FIGS. 1-3, for example, a first radio technology RF chain 302 may be one RF resource 218a, and a second radio technology RF chain 304 may be part of another RF resource 218b. In some embodiments, the first and second radio technology RF chains 302, 304 may include components operable for transmitting data. When transmitting data, a data processor 306, 320 may format, encode, and interleave data in preparation for transmission. A modulator/demodulator 308, 318 may modulate a carrier signal with encoded data, for example, by performing Gaussian minimum shift keying (GMSK). One or more transceiver circuits 310, 316 may condition the modulated signal (e.g., by filtering, amplifying, and up-converting) to generate a RF modulated signal for transmission. The RF modulated signal may be transmitted, for example, to the base station 130, 140 via an antenna, such as the antenna 220a, 220b.

The components of the first and second radio technology RF chains 302, 304 may also be operable to receive data. When receiving data, the antenna 220a, 220b may receive RF modulated signals from the base station 130, 140 for example. The one or more transceiver circuits 310, 316 may condition (e.g., filter, amplify, and down-convert) the received RF modulated signal, digitize the conditioned signal, and provide samples to the modulator/demodulator 308, 318. The modulator/demodulator 308, 318 may extract the original information-bearing signal from the modulated carrier wave, and may provide the demodulated signal to the data processor 306, 320. The data processor 306, 320 may de-interleave and decode the signal to obtain the original, decoded data, and may provide decoded data to other components in the wireless device.

Operations of the first and second radio technology RF chains 302, 304 may be controlled by a processor, such as the baseband processor(s) 216. In the various embodiments, each of the first and second radio technology RF chains 302, 304 may be implemented as circuitry that may be separated into respective receive and transmit circuits (not shown). Alternatively, the first and second radio technology RF chains 302, 304 may combine receive and transmit circuitry (e.g., as transceivers associated with SIM-1 and SIM-2 in FIG. 2).

As described, interference between the first and second radio technology RF chains 302, 304, such as desense and interpolation, may cause the desired signals to become corrupted and difficult or impossible to decode. For example, a transmission signal 330 sent by the first radio technology RF chain 302 may be errantly received by the second radio technology RF chain 304. In addition, electronic noise 332 from circuitry, such as the baseband processor 216, may also contribute to interference on the first and second radio technology RF chains 302, 304. To avoid such interference, the multi-technology communication device may implement various embodiment algorithms to estimate a nonlinear interference caused by the transmissions signal 330 and cancel the estimated nonlinear interference from victim signals received by the second radio technology RF chain 304.

For the purpose of providing a clear disclosure, signals received by a wireless communications device will be referred to as victim signals. However, victim signals may also be transmission signals experiencing desense caused by incoming received signals.

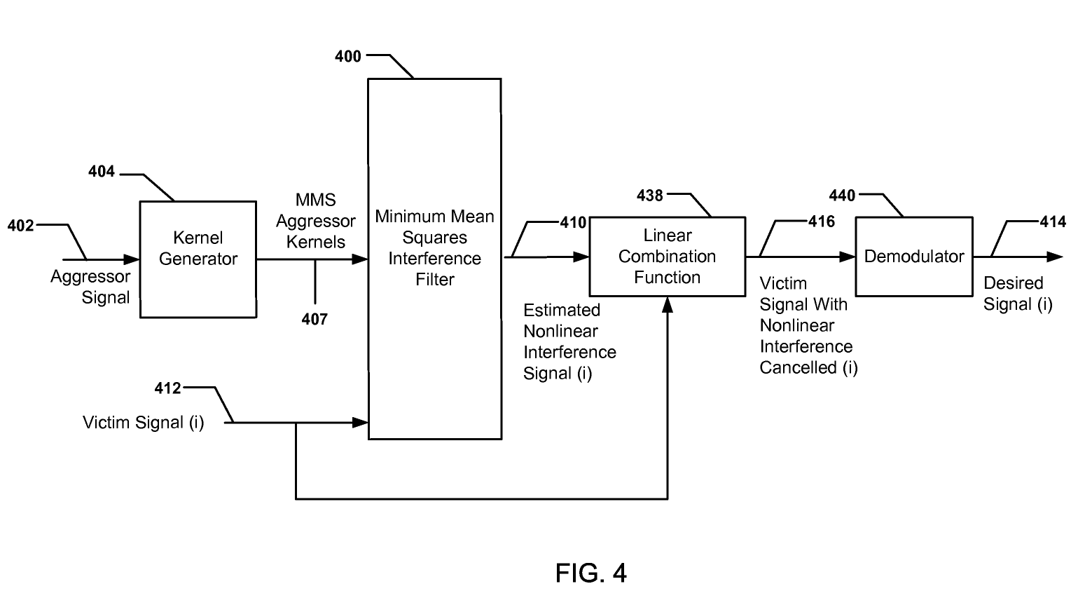

The various embodiments provide efficient algorithms that may be implemented in circuitry, in software, and in combinations of circuitry and software for estimating the nonlinear interference present in a victim signal without requiring a complete understanding or rigorous mathematical model of the aggressor signal or sources of the nonlinear interference. The embodiment algorithms are premised upon a general mathematical model of the nonlinear interferences, which for completeness is described below with reference to equations 1-3. These equations are not directly solvable, and provide a model for structuring that nonlinear interference cancellation system according to various embodiments described below beginning with FIG. 4.

In this mathematical model, the actual nonlinear interference signal is modeled as the interference experienced by a victim signal as a result of one or more aggressor signal(s) z(i). In this model, the actual nonlinear interference signal L(i) caused by one or more hypothetical aggressor signal(s) z(i) on a hypothetical victim signal at a time “i” may be represented by the function:

L(i)=\sqrt{JNR}·J(z(i)) [Eq. 1]

where JNR is a jammer to noise ratio (a value that could be measured at time i) and J(z(i)) is a Jacobean matrix of all hypothetical aggressor signals z(i). JNR is a value that can be calculated based on measurements but is not required in the embodiment algorithms.

Similarly, the estimated nonlinear interference signal \hat{L}(i) for a time “i” may be expressed as:

\hat{L}(i)=\sqrt{JNR}·Ĵ(z(i)) [Eq. 2]

where JNR is again the jammer to noise ratio and Ĵ(z(i)) is a jacobian matrix of all aggressor signals z(i) (discussed in detail with reference to FIGS. 4-6A below). The estimated function \hat{L}(i) is an estimate of the actual nonlinear interference signal L(i) as discussed above. This estimated nonlinear interference signal \hat{L}(i) may be the result of manipulation of the aggressor signal z(i) by the minimum mean squares interference filter according to various embodiments as described below.

A victim signal y(i), may be the signal actually received by the multi-technology wireless communications device and may be degraded as a result of interference from the one or more aggressor signals z(i). The victim signal y(i) for the time “i” received by the multi-technology wireless communications device may be represented as the function:

y(i)=\sqrt{SNR}·x(i)+\sqrt{JNR}·J(z(i))+v(i) [Eq. 3]

where elements of the victim signal y(i) may be expressed in terms of the signal-to-noise ratio (SNR), the intended receive signal represented as a function x(i), the jammer-to-noise ratio (JNR) of equation 2, the Jacobian matrix of all aggressor signals z(i), and a noise in the victim signal, such as thermal noise an inter-device interference, represented by the function v(i). As with equations 1 and 2 above, the victim signal in equation 3 is provided as a mathematical representation illustrating the relationship between the various signals.

Theoretically, the intended received signal x(i) may be obtained by rearranging the terms in Equation 3 to solve for x(i). A direct solution of these model equations may not be feasible in real time, particularly within mobile communication devices that have limited processing power. Therefore, the various embodiments employ a minimum mean squares interference filter to generate an estimate of the nonlinear interference signal L(i) without directly solving equation 1-3.

FIG. 4 illustrates a nonlinear interference cancellation system including a minimum mean squares interference filter 400 that may be used to remove an estimate of the nonlinear interference from a victim signal in accordance with various embodiments. With reference to FIGS. 1-4, the minimum mean squares interference filter 400 may be implemented in a multi-technology wireless communications device (e.g., 110, 120, 200 in FIGS. 1 and 2) in software, general processing hardware, dedicated hardware, or a combination of any of the preceding. The minimum mean squares interference filter 400 may be configured to receive an aggressor signal 402 and a victim signal 412 at a time “i”. The minimum mean squares interference filter 400 may be configured to produce an estimated nonlinear interference signal 410 for a time “i”. The estimated nonlinear interference signal 410 may then be cancelled from the victim signal 412 y(i).

In various embodiments, the minimum mean squares interference filter 400 may be configured to receive an aggressor kernel matrix 407 generated by a kernel matrix generator 404. The aggressor kernel matrix 407 may be the result of kernel functions of different order applied to all or a portion of the aggressor signal 402. The minimum mean squares interference filter 400 may be configured to utilize the aggressor kernel matrix to calculate an estimated nonlinear interference signal 410 for the time “i”.

In some embodiments, the minimum mean squares interference filter 400 may be a minimum mean squares based machine learning technique and linear filtering technique implemented in a multi-technology wireless communications device. For any time “i”, the minimum mean squares interference filter 400 may be implemented to help identify an intended receive signal x(i), the signal the communications device would have received but for experienced interference, from among the elements of the actually received victim signal 412 y(i). Given an aggressor signal 402 z(i), the minimum mean squares interference filter 400 may implement minimum mean squares machine learning algorithms combined with linear filtering to produce an estimated nonlinear interference signal 410 that may be cancelled from the victim signal 412.

The estimated nonlinear interference signal 410 for the time “i” may be used by a linear combination function 438 to cancel the estimated nonlinear interference signal 410 from the victim signal 412. For example, the linear combination function 438 may subtract, add, or otherwise mathematically manipulate portions of the estimated nonlinear interference signal 410 affecting the victim signal 412. Thus, unnecessary elements of the victim signal 412 caused by aggressor signal 402 interference may be removed from the victim signal 412 and elements obscured by aggressor signal 402 interference may be recaptured. The result of the linear combination function 438 may be the victim signal with the nonlinear interference cancelled 412. A demodulator 440 may receive the victim signal with the nonlinear interference cancelled 416 and demodulate it to produce the desired signal 414.

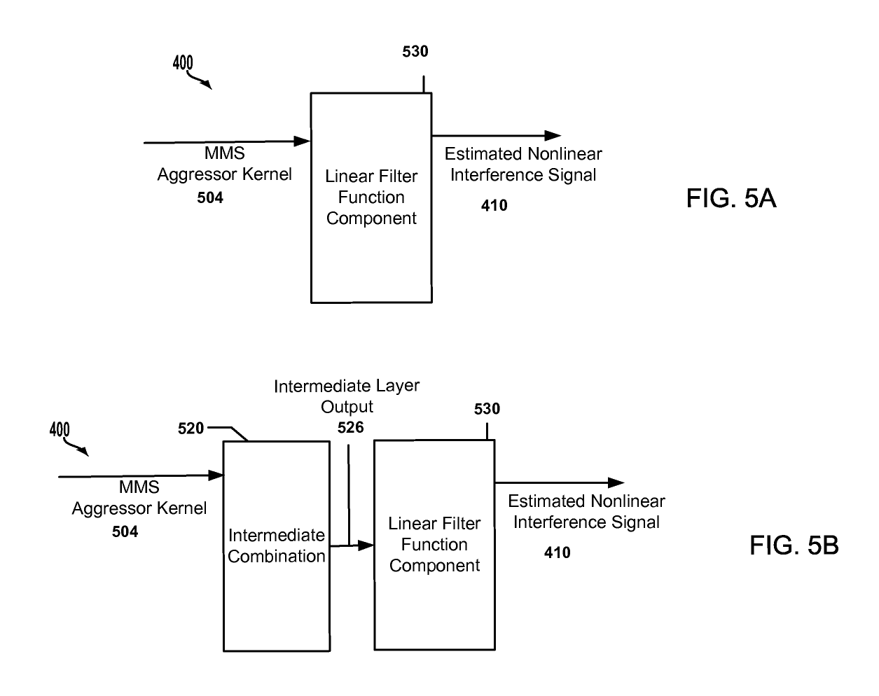

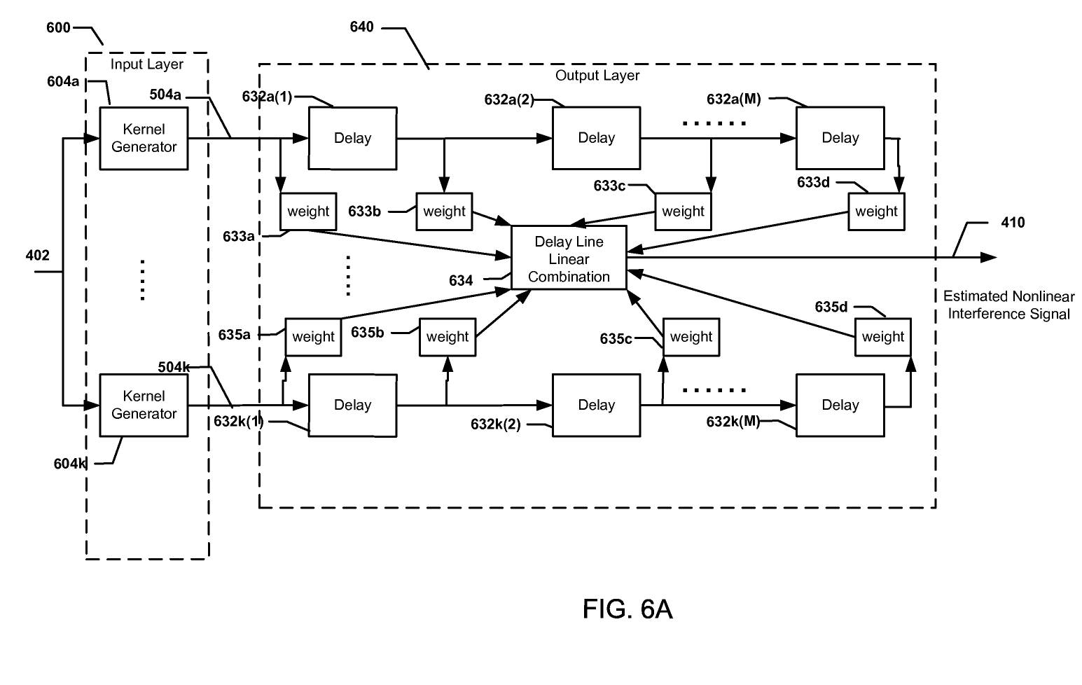

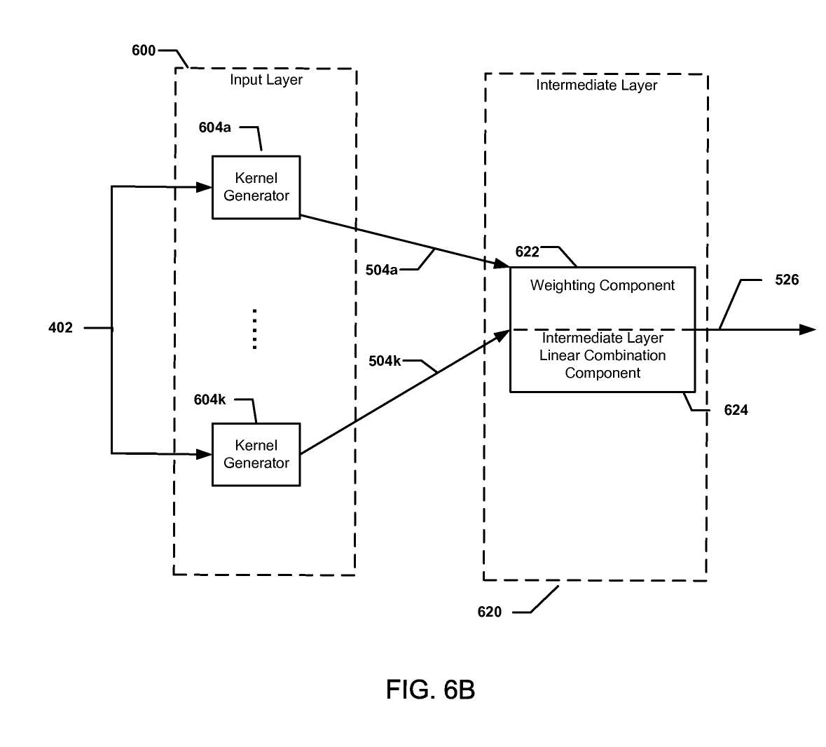

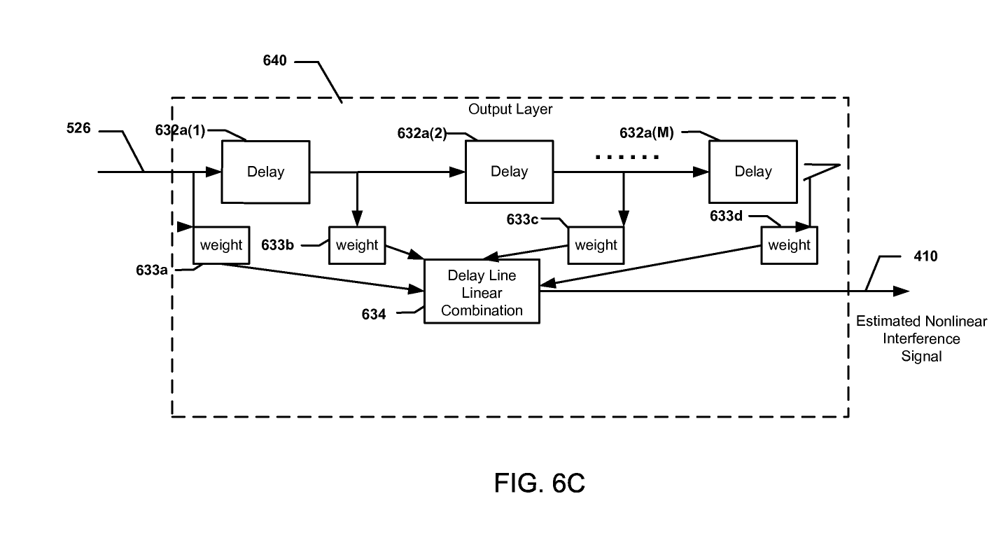

In various embodiments, the minimum mean squares interference filter 400 may include computer implementations of minimum mean squares machine learning algorithms. One or more aggressor signals 402 z(i) may be provided as input to the minimum mean squares interference filter 400 as will be discussed in greater detail with reference to FIGS. 5A-6C below. The aggressor input(s) may be manipulated by the minimum mean squares interference filter 400 in a series of mathematical operations and estimations to generate the estimated nonlinear interference signal 410. Because of the mathematical complexity associated with calculation of an actual nonlinear interference signal, machine learning algorithms and linear filter functions (e.g., Hammerstein structure) may be implemented to produce an estimate of an experienced nonlinear interference signal such as the estimated nonlinear interference signal 410. As such, the various formulas described herein are mathematical representations of actual and estimated signals that are utilized or produced by the minimum mean squares interference filter 400. These mathematical representations may not be actively calculated by the minimum mean squares interference filter 400, but are provided to enable one of ordinary skill in the art to realize the relationships between elements of the various signals as they are manipulated by the operations described herein.

As discussed with reference to equations 1 and 2 above, the estimated nonlinear interference signal 410 may be described in terms of one or more aggressor signals 402 z(i). Thus, the production of the estimated nonlinear interference signal 410 may depend on the manipulation of the aggressor signals 402 by the minimum mean squares interference filter 400. In some embodiments, the minimum mean squares interference filter may accept the result of a kernel function executed on the aggressor signal 402 (i.e., aggressor kernel(s)) and may produce an MMS aggressor kernel matrix for use in estimation of nonlinear interference. These embodiments will be discussed in greater detail with reference to FIGS. 5A-6C below.

Generating the estimated nonlinear interference signal 410 for the time “i” may be accomplished by the minimum mean squares interference filter 400 in a non-blind manner. In other words, the minimum mean squares interference filter 400 may calculate the estimated nonlinear interference signal 410 knowing some information about the radio access technology used by the multi-technology wireless communications device and/or the kind of interference occurring on the victim signal 412. This information may include the radio band of the aggressor and/or victim signal and other transmission information. In embodiments in which the aggressor signal 402 is converted into an aggressor kernel, the order of the kernel function may be dictated by the transmission information. For example, in various embodiments, aggressor signals transmitted on a particular radio band may require manipulation using a kernel function of order “b” to produce an aggressor kernel.

The aggressor signal 402 may have a mathematical representation that is a complex structure with imaginary and real elements. Thus, the aggressor signal may include a real aggressor signal component and an imaginary aggressor signal component. The real aggressor signal component may be represented by z_{Real}(i), and the imaginary aggressor signal component may be represented by z_{Imaginary}(i). As discussed further with reference to FIG. 6B, an intermediate layer of the minimum mean squares interference filter 400 may produce a jammer signal estimate. A jammer signal estimate may include a real component and an imaginary component, (e.g., intermediate layer output 526 in FIG. 5B). A linear filter, such as a finite impulse response filter, may receive a jammer signal estimate that includes a real jammer signal estimate component and an imaginary real jammer signal estimate component. The linear filter may use the jammer signal estimate to produce a complex estimated nonlinear interference (i.e., an estimated nonlinear interference signal having a complex structure), as discussed further with reference to FIGS. 5A-6C. The complex estimated nonlinear interference may include an estimated nonlinear interference component (real) and an estimated nonlinear interference component (imaginary).

As described, the aggressor signal 402 may be represented as a function z(i) for the time “i”. The kernel generation function employed by the kernel matrix generator 404 may be one of various kernel functions such a harmonic or exponential expansion of order “r”, for example z(i). The resulting aggressor kernel may have a complex structure with both real and imaginary components. Thus, the aggressor kernel \hat{z}(i) may be represented as:

\hat{z}_{Real}(i)=Real part of ker(z(i)) [Eq. 4a]

\hat{z}_{Imaginary}(i)=Imaginary part of ker(z(i)) [Eq. 4b]

where ker(z(i)) is the application of a selected kernel function on the aggressor signal 402 z(i) by the kernel matrix generator 404. The kernel matrix generator 404 may utilize the generated real and imaginary aggressor kernels to build an aggressor kernel matrix as will be discussed in greater detail with reference FIGS. 5A-6C below.

The aggressor kernel matrix 407 may include a number of MMS aggressor kernel elements determined by the order of a kernel function. For example, a kernel function of order=7 may produce four aggressor kernel components and thus the associated component matrix may have four elements. Each element may correspond to an execution of a kernel function of order 1, 3, 5, and 7.

The MMS aggressor kernel matrix A(i) may be represented in terms of a number of “K” kernels, a number of linear filter taps “M”, and sample size “N”. Thus, the MMS aggressor kernel matrix may be represented by the functions: by the function:

A(i)_{N×KL}=[Z(i)Z(i−1) . . . Z(i+L−1)] [Eq. 5]

where A(i) is the combined aggressor kernel matrix, N is a number of signal samples, K is a number of aggressor kernels, M is a number of linear filter function 530 delay line “taps”, and L is an end time/iteration.

As discussed with reference to FIG. 4 and with further reference to FIG. 6A, the real aggressor kernel matrix and the imaginary aggressor kernel matrix may be received at the intermediate layer and used to produce the real jammer signal estimate component. The linear filter may receive the real jammer signal estimate component and produce the estimated nonlinear interference signal 410.

FIGS. 5A-5B illustrate a minimum mean squares interference filter 400 in accordance with various embodiments. With reference to FIGS. 1-5B, the minimum mean squares interference filter 400 may be implemented in a multi-technology wireless communications device (e.g., 110, 120, 200 in FIGS. 1 and 2) in software, general processing hardware, dedicated hardware, or a combination of any of the preceding. The minimum mean squares interference filter 400 may include an intermediate layer and/or an output layer, which may further the calculation of the estimated nonlinear interference signal for time “i”. The intermediate layer may include one or more weighting components and linear combinations, collectively referenced as an intermediate combination 520. The operations of the intermediate layer may produce an intermediate layer output 526, which may be passed to a linear filter function 530 of the output layer. The linear filter function 530 may use the intermediate layer output 526 to produce an estimated nonlinear interference signal for time “i”.

With reference to FIG. 5A, in various embodiments, an aggressor signal 402 may be passed to a kernel matrix generator 404, which may execute one or more kernel functions to produce multiple MMS aggressor kernels 504. The MMS aggressor kernels 504 may be combined into a single aggressor kernel matrix “A” (described above with reference to FIG. 4). The aggressor kernel matrix may be passed as an input to a linear filter function 530 of an output layer of the minimum mean squares interference filter 400 to produce an estimated nonlinear interference signal 410.

The output layer may include a set linear filters (e.g., finite impulse response filters) having “K” delay lines and “M” taps on each line. A set of weights represented by “u” defined by a minimum mean squares function may augment the delay line outputs during execution of the an individual filter function on each set of kernels within the aggressor kernel matrix. An exemplary minimum mean squares function may be represented by the expressions:

\hat{u}=Uy(i)=(σ²I+A^{H}(i)A(i))⁻¹A^{H}(i)y(i) [Eq. 6a]

where U=arg min_{U}E∥u−Uy(i)∥² and [Eq. 6b]

σ²=(y^{H}(i)y(i)−y^{H}A(i)\hat{u})/N [Eq. 6c]

where \hat{u} is a matrix of weight factors, A(i) is the combined matrix of MMS aggressor kernels, N is a number of signal samples, σ is a variance, and y(i) is the victim signal 412.

Results of the linear filter function 530 may be expressed in terms of the aggressor matrix and the set of weights “u”. Thus, the estimated nonlinear interference signal 410 \hat{L}(i) for the time “i” may be represented by the following functions:

\hat{L}(i)=A(i)\hat{u} [Eq. 7]

where \hat{L}(i) is an estimated nonlinear interference signal 410, A(i) is a combined intermediate layer outputs, and \hat{u} is a matrix of one or more weight factors for the linear filter function 530. The produced estimated non-linear interference may be cancelled from the received victim to obtain an intended receive signal “x(i)”.

With reference to FIG. 5B, in some embodiments, the MMS aggressor kernels 504 may be used as individual inputs for an intermediate combination 520. The MMS aggressor kernels 504 may be augmented with a set of one or more weight factors and linearly combined in an intermediate combination 520. The intermediate combination 520 may include a linear combination component that may execute a multiplication or a summation on the augmented MMS aggressor kernels 504 resulting in an intermediate layer output 526.

In various embodiments, the intermediate layer may include weighting components that augment the elements of the MMS aggressor kernels 504 with a set of one or more weight factors “\hat{ω}”. The one or more weight factors may be defined by a minimum mean squares function operating on the combined aggressor kernel matrix Z(i) 504. An exemplary minimum mean squares function for training the one or more weight factors of the intermediate layer may be expressed by the function:

\hat{w}_{K}=W_{K}y(i)=(σ²I+Z^{H}(i)Z(i))⁻¹Z^{H}(i)y(i) [Eq. 8a]

where W_{K}=arg min_{W}_{_{K}}E∥w_{K}−W_{K}y(i)∥² and [Eq. 8b]

σ²=(y^{H}(i)y(i)−y^{H}Z(i)\hat{w}_{K})/N [Eq. 8c]

where \hat{ω} is a matrix of weight factors, Z(i) is the matrix of MMS aggressor kernels 504, N is a number of signal samples, σ is a variance, and y(i) is the victim signal 412.

Elements of the augmented MMS aggressor kernels 504 may be summed by an intermediate layer linear combination component during or after the augmentation. The augmentation and summation may produce an intermediate layer output 526. An intermediate layer output \hat{s}(i) (i.e., jammer signal estimate) may be expressed in terms of the weight factors w and a combined aggressor kernel matrix Z(i) by the functions:

\hat{s}(i)=Z(i)\hat{w}_{K} [Eq. 9]

where \hat{s}(i) is a vector comprising elements that represent individual intermediate layer outputs for a time “i”, Z(i) is a combined aggressor kernel matrix composed of the MMS aggressor kernels 504, and w are one or more weight factors.

The intermediate layer output 526 may be passed to a linear filter function 530 of the output layer. The linear filter function 530 may have a Hammerstein structure or other finite impulse response filter function. In various embodiments, the intermediate layer output 526 may be summed and augmented by a second set of one or more weight factors during execution of the linear filter function 530 to produce an estimated nonlinear interference signal 410. The weight factors may be determined using a minimum mean squares method on the intermediate layer output 526. The second set of one or more weights “\hat{w}_{F}” may be described in terms of the intermediate layer output 526 as the function:

\hat{w}_{F}=W_{F}y(i)=(σ²I+S^{H}(i)S(i))⁻¹S^{H}(i)y(i) [Eq. 10a]

where W_{F}=arg min_{W}_{_{F}}E∥w_{F}−W_{F}y(i)∥², [Eq. 10b]

σ²=(y^{H}(i)y(i)−y^{H}S(i)\hat{w}_{F})/N, and [Eq. 10c]

S(i)_{N×L}=[\hat{s}(i)\hat{s}(i−1) . . . \hat{s}(i+L−1)]^{T} [Eq. 10d]

where \hat{w}_{F} is a matrix of weight factors for the linear filter function, S(i) is a vector comprising elements that represent individual intermediate layer outputs for a time “i, N is a number of signal samples, σ is a variance, and y(i) is the victim signal 412.

Results of the linear filter function 530 may be an estimated nonlinear interference signal 410. The estimated nonlinear interference signal 410 \hat{L}(i) for the time “i” may be represented by the function:

\hat{L}(i)=S(i)\hat{w}_{F} [Eq. 11]

where \hat{L}(i) is an estimated nonlinear interference signal 410, Sₛ(i) is a combined intermediate layer outputs, and \hat{w}_{F} is a matrix of a one or more weight factors for the linear filter function. Thus, the estimated nonlinear interference signal 410 is dependent on both the intermediate layer output 526. The produced estimated non-linear interference may be cancelled from the received victim to obtain an intended receive signal “x(I)”.

FIG. 6A illustrates interactions between components of the minimum mean squares interference filter (e.g., 400 in FIG. 4) with an aggressor signal input (e.g., 402 in FIG. 4) in accordance with various embodiments. With reference to FIGS. 1-6A, the minimum mean squares interference filter may include an input layer 600 and an output layer 640. For purposes of clarity, the minimum mean squares interference filter is described with reference to a single aggressor signal; however, multiple aggressor signals may interfere with the victim signal and consequently multiple aggressor signals may be used to produce the estimated nonlinear interference signal 410.

In a single phase minimum mean squares interference filter, such as that shown in FIG. 6A, the input layer 600 may receive the aggressor signal 402 and pass it to Kernel generators 604a-604k. The Kernel generators 604a-604k may apply one or more kernel functions to the signal (e.g., polynomial and/or exponential functions), resulting in a set of MMS aggressor kernels 504a-504k, where “K” is the number of kernel functions applied (i.e., the number of kernels produced). The MMS aggressor kernels 504a-504k generated by the input layer 600 may be then inputted into the output layer 640 and modified to generate the estimated nonlinear interference signal 410. In one example, the output layer 640 may include one or more linear filter functions 530 represented by a delay lines 632a-632k. Each of the MMS aggressor kernels 504a-504k may be passed to a separate linear filter function 530 represented by delay lines 632a-632k. Thus, each MMS aggressor kernel 504a-504k may be processed by a corresponding delay line 632a-632k of an individual linear filter function. Each of the MMS aggressor kernels 504a-504k may be passed directly to delay lines 632a-632k from the input layer 600.

In various embodiments, the MMS aggressor kernels 504a-504k may be combined to generate a combined aggressor kernel matrix. A minimum mean squares function may be executed on the combined aggressor kernel matrix to produce a set of one or more weight factors for the linear filter functions. These weight factors may be associated with weighting components 633a-633d, 635a-635d (where “d” may be equal to a number of delay line taps “M”) and may be used to augment the received MMS aggressor kernels 504a-504k.

The number of delays in each of the delay lines 632a-632k and the number of associated weighting components 633a-633d, 635a-635d applied to the MMS aggressor kernels 504a-504k may correspond to the number of taps “M”. In an embodiment, the weighting components 633a-633d, 635a-635d of the output layer 640 may augment each of the received MMS aggressor kernels 504a-504k with a weight factor during each iteration of the delay line of a linear filter function. After each augmentation, the result may be passed to and received by a common delay line linear combination 634. The delay line linear combination 634 may receive augmented inputs from each of the individual delay lines 632a-632k at each tap 1-M, and may sum or multiply the received input. The augmentation and linear combination (e.g., execution of the linear filter function) may produce an estimated nonlinear interference signal 410.

In some embodiments, the estimated nonlinear interference signal 410 may be cancelled or subtracted from the victim signal 412 so that the victim signal 412 may be decoded and understood by the multi-technology communications device. In some embodiments, the estimated nonlinear interference signal 410 may be used to train the weight factors of the minimum mean squares interference filter.

FIGS. 6B-6C illustrates interactions between components of the minimum mean squares interference filter (e.g., 400 in FIG. 4) with an aggressor signal input (e.g., 402 in FIG. 4) in accordance with various embodiments. With reference to FIGS. 1-6C, the minimum mean squares interference filter may include an input layer 600, an intermediate layer 620, and an output layer 640. For purposes of clarity, the minimum mean squares interference filter is described with reference to a single aggressor signal; however, multiple aggressor signals may interfere with the victim signal and consequently multiple aggressor signals may be used to produce the estimated nonlinear interference signal.

In some embodiments, such as the embodiments shown in FIGS. 6B-C, the input layer 600 is similar to the input layer as described in FIG. 6A at which the aggressor signal 402 is received. At the input layer 600 kernel generators 604a-604k may apply multiple kernel functions to the aggressor signal 402 to produce a set of MMS aggressor kernels 504a-504k for “K” kernel function executions. The MMS aggressor kernels 504a-504k may be passed to an intermediate layer 620. In some embodiments, the intermediate layer 620 may include components for carrying out augmentation and linear combination of the MMS aggressor kernels 504a-504k. For example, a weighting component 622 may augment each of the MMS aggressor kernels 504a-504k with a set of one or more weight factors. The weights may be trained during an initial training phase of the interference filter as discussed with reference to FIG. 5B above. Each weight factor may be individually applied to a corresponding MMS aggressor kernel to produce augmented MMS aggressor kernels. The weighting factors may be applied prior to, during, or after summation of the MMS aggressor kernels 504a-504k by the intermediate linear combination component 624. Each of the augmented MMS aggressor kernel elements may be summed or multiplied to produce a set of intermediate layer outputs. The augmentation and linear combination of the MMS aggressor kernels 504a-504k may produce an intermediate layer output 526 (i.e., jammer signal estimate), which may be passed to an output layer 640.

In various embodiments, an output layer 640 such as that shown in FIG. 6C, may receive intermediate layer output 526. The output layer 640 may execute a single delay line linear filter function (e.g., 632a of FIG. 6A), including delay lines 632a(1)-(M) on the intermediate layer output 526. As discussed above with reference to FIG. 6A, the single delay line linear filter function may include further augmentation by weighting components 633a-633d and a delay line linear combination 634. A result of the linear filter function may be an estimated nonlinear interference signal 410. The operation of the linear filter function of FIG. 6C may be substantially similar to the operation of individual linear filter functions described with reference to FIG. 6A above. A difference between the embodiments may be that the delay line linear combination of FIG. 6C sums and combines only the outputs of taps from a single delay line 632a(1)-(M), but the embodiment of FIG. 6A includes a delay line linear combination 634 that combines the results of taps from delay lines 632a-632k. Both embodiments may produce an estimated nonlinear interference signal 410.

In various embodiments, output layer weight training may occur prior to execution of the interference filter. In some embodiments, weight training may be executed using a minimum mean squares method. In some embodiments, initial weight training may include setting the output layer linear filter function taps to 1, 0, 0 . . . , thereby indicating that the filter is empty. One MMS aggressor kernel (e.g., the third order kernel) may be passed through a single delay line of an linear filter function with a filter weight set to a predetermined constant (e.g., one, zero point five, etc.). A minimum mean square calculation may be executed on the result of the linear filter function to produce an estimated set of filter weights. A full set of aggressor kernels may then be passed through a full set of linear filter functions utilizing the estimated set of filter weights to produce a set of “k” estimated training kernels. The estimate training kernels may be passed to an intermediate layer 620, augmented with an initial estimated intermediate weight, and linearly combined. Like the estimated filter weights, the estimated intermediate weights may be set to a predetermined constant during the initial training. A minimum mean squares function may be executed on the result of the augmentation and linear combination to produce a set of intermediate weights. These intermediate weights may be applied to received MMS aggressor kernels 504a-504k during active interference filtering procedures, and may be retrained as needed.

Both the intermediate layer weights and the output layer weights may be trained using a three stage minimum mean squares training process. The intermediate layer weights may be trained using the first two training stages. The output layer, or filter weights, may be trained by first obtaining the intermediate layer weights and then executing a third stage of training

The first stage of the weight training may include a linear filter function. Execution of the linear filter function may include utilizing a representative kernel (e.g., z₃) in calculating a set of estimated filter weights according to equations 8a-8c as discussed with reference to FIG. 5B above.

The result of the first stage of training may be a set of initial estimated weights \hat{ω}_{Est} and set of estimated kernels φ(i), represented by the function:

φ(i)=[z_{θ}(i+1)z_{θ}(i)z_{θ}(i−1)]\hat{ω}_{Est} where θ=1, 3, 5, . . . M [Eq. 12]

where φ(i) is a set of estimated kernels, z_{θ}(i) is an aggressor signal for a time “i”, \hat{ω}_{Est} is a set of estimated weights, and M is a number of linear filter function taps. The set of estimated kernels and initial estimated weights may be passed as inputs to the second stage of weight training.

At the second stage of weight training, the estimated kernels and the initial estimated weights may be augmented and linearly combined in a manner consistent with the intermediate combination 520 of intermediate layer 620. The intermediate layer weights may be estimated by applying a matrix of the estimated kernels to a minimum mean square calculation according to the equations 10a-10d above (substituting S(i) for φ(i)).

The result of the second stage of training may be the set of intermediate weights \hat{ω}_{K} and an estimated intermediate layer output s(i), represented by the function:

s(i)=[z₁(i)z₃(i) . . . z_{P}(i)]\hat{w}_{K} [Eq. 13]

where s(i) is an estimated intermediate layer output, zⱼ(i) is an aggressor signal for the j-th signal sample, P is equal to the number of linear filter function taps “M”, and \hat{ω} is a k+th estimated weight for a number of kernels “K”.

The set of intermediate weights may be ready for execution in active interference filtering. Before active filtering can begin, the third stage of the training process may commence to produce a set of filter weights. Thus, the intermediate weights and the estimated intermediate output may be passed as inputs to the third stage of weight training.

The third stage of weight training may include execution of a linear filter function similar to that of stage one of the weight training procedure. In the third stage of weight training, the estimated intermediate output may be used as an input in lieu of the representative kernel. The linear filter weights \hat{w}_{F} may be trained in the third stage according to the equations 10-10d as discussed above with reference to FIG. 5B.

In some embodiments, the error of the estimated nonlinear interference signal 410 may be compared to an error threshold to determine whether the error is acceptable. Determining that the error present in an estimation of the nonlinear interference signal is unacceptable may prompt the minimum mean squares interference filter 400 to train or retrain any of the weight factors to reduce the error in the estimated nonlinear interference signal 410. Training of the weight factors may be regressively executed to further reduce the error of the estimated nonlinear interference signal 410. In some embodiments, satisfactory weight factors may be reused for subsequent nonlinear interference estimations. The reuse of previously determined weight factors may be based on one or more parameters, such as time since the last adjustment of the weight factors and how the error in the estimated nonlinear interference signal 410 compares to the error threshold, and the like.

In the various examples, components of the minimum mean squares interference filter are shown individually or in combination. It should be understood that these examples are not limiting and the various other configurations of the components are considered. For example, the intermediate layer components are illustrated as separate components. However, any of the layers and/or components may be embodied in combination with other components, and multiples of the same component may be embodied in a single component.

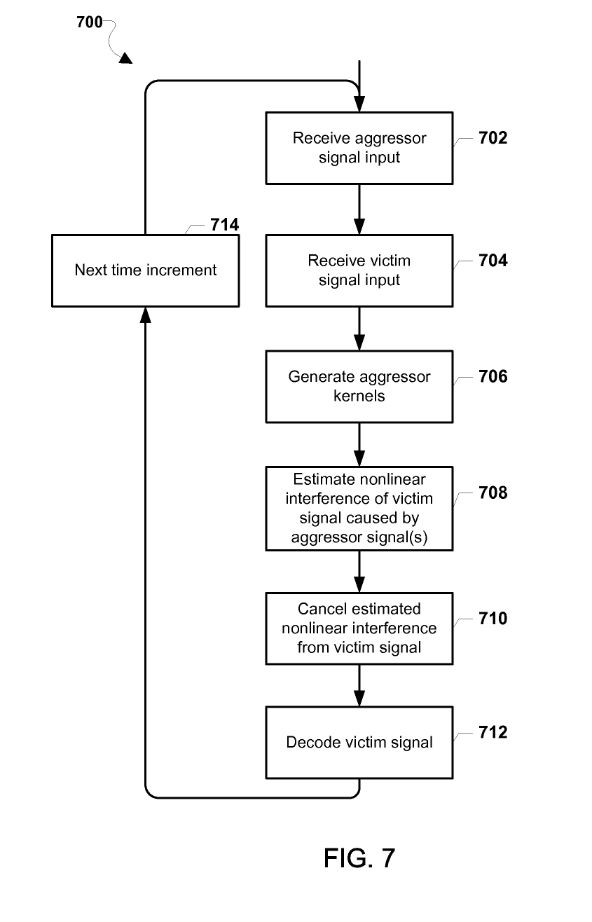

FIG. 7 illustrates a method 700 for canceling nonlinear interference from a received signal using a minimum mean squares interference filter (e.g., 400 in FIG. 4A) in a multi-technology wireless communications device in accordance with various embodiments. With reference to FIGS. 1-7, the method 700 may be executed in a computing device (e.g., 110, 120, 200) using software, general purpose or dedicated hardware, or a combination of software and hardware, such as the general purpose processor 206, baseband processor 216, or the like. In block 702, the multi-technology communication device may receive an aggressor signal. The aggressor signal may be received by a first radio access technology of the multi-technology communication device from a transmission of a second radio access technology of the same multi-technology communication device.

In block 704, the multi-technology communication device may receive a victim signal. The victim signal may be received by the first radio access technology of the multi-technology communication device from a transmitting source device separate from the multi-technology communication device. The victim signal may initially be unaffected by interference when transmitted from the transmitting source device. However, the victim signal may experience interference caused by the aggressor signal during transmission to the multi-technology communication device.

In block 706, the multi-technology communication device may generate a set of aggressor kernel from the aggressor signal. The aggressor signal may include a real component and an imaginary components. The aggressor signal may be passed as inputs to a kernel function such as a harmonic or exponential function (e.g., an harmonic expansion), where the order of the kernel function may be dictated by information known about the transmission technology of the aggressor or victim signal. The kernel function may be executed (r/2)+1 times where “r” is the highest order of the kernel function, and for each execution of the kernel function from order 1, 3, 5 . . . “r” the result may be added to a set of aggressor kernels.

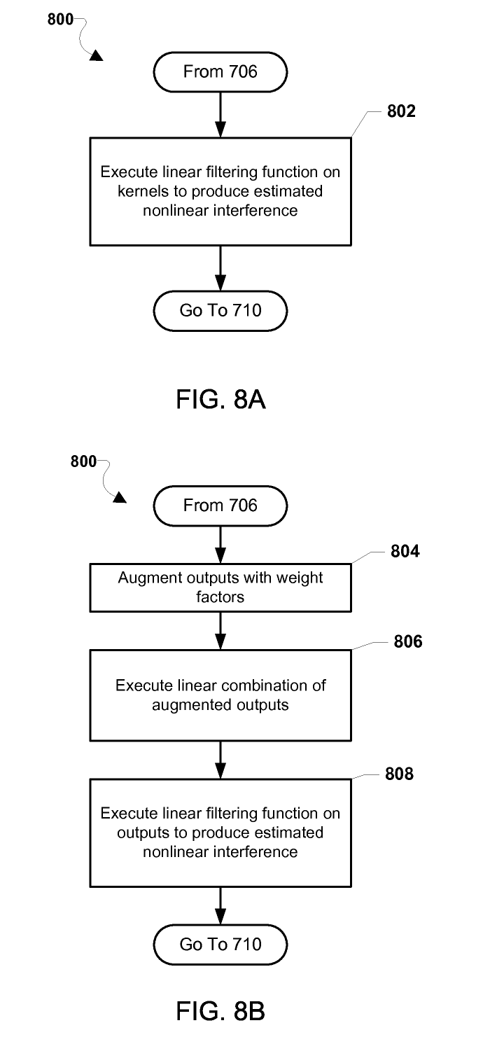

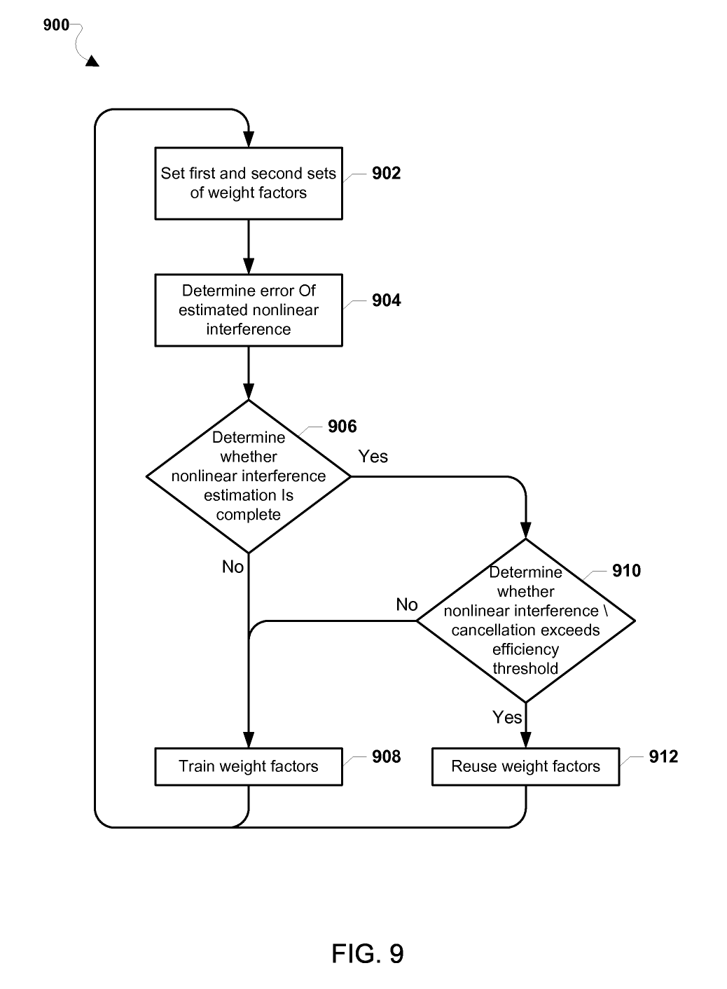

In block 708, the multi-technology communication device may estimate the nonlinear interference of the victim signal caused by the aggressor signal(s). This estimation of the nonlinear interference is discussed in further detail (e.g., with reference to FIGS. 8A-9). In block 710, the multi-technology communication device may cancel an estimated nonlinear interference signal from the victim signal. Canceling or removing the estimated nonlinear interference from the victim signal may be implemented in a variety of known ways, such as filtration, transformation, extraction, reconstruction, and suppression. In block 712, the multi-technology communication device may decode the victim signal without presence of the interference by the aggressor signal(s). In block 714, the multi-technology communication device may advance to the next time interval “i” (e.g., move to the current time interval) and begin the process again with regard to aggressor and victim signals for the current time “i”.

FIGS. 8A-B illustrate methods 800 for estimating nonlinear interference using a minimum mean squares interference filter (e.g., 400 in FIG. 4) in a multi-technology wireless communications device in accordance with various embodiments. With reference to FIGS. 1-8B, the method 800 may be executed in a computing device (e.g., 110, 120, 200) using software, general purpose or dedicated hardware, or a combination of software and hardware, such as the general purpose processor 206, baseband processor 216, or the like. The method 800 may be included in method 700 in FIG. 7 as part of block 708. As described above, the victim signal and the aggressor signal or aggressor kernel may be used by the multi-technology communication device as input signals for the minimum mean squares interference filter. The victim signal and the aggressor signal or aggressor kernel may be received by the input layer of the minimum mean squares interference filter. The aggressor kernels generated from the aggressor signal or aggressor kernel may be used as intermediate layer input signals and maybe manipulated in the estimation of the estimated nonlinear interference.

With reference to FIGS. 1-8A, in block 802 a multi-technology communication device may execute a linear filter function on received MMS aggressor kernels to produce an estimated nonlinear interference. Each of the kernels may be assigned to a single linear filter function. The linear filter function may augment the received MMS aggressor kernels with filter weights and may combine the results in a delay line linear combination. The result may be the estimated nonlinear interference, which may be cancelled from the received victim signal.

With reference to FIGS. 1-8B, in block 804, the multi-technology communication device may augment the aggressor kernels with a first set of weight factors. As described above, in various embodiments, the weight factors may be generated using the three stage training process, and/or trained as described with reference to FIG. 9.

In block 806, the multi-technology communication device may execute a linear combination of the augmented MMS aggressor kernels. In some embodiments, the augmentation and linear combination may be executed through mathematical and/or logical operations. The operations implementing the augmentation may result in a multiplication of a respective weight factor with a respective aggressor kernel element. The operations implementing the linear combination may result in the summation of the augmented aggressor kernels. In some embodiments, multiplication of weight factors with the MMS aggressor kernels may occur during the summation such that a weight factor is multiplied by an element at subsequent iterations of the summation. The linear combination of the augmented elements may produce the intermediate layer outputs.

In determination block 808, the multi-technology communication device may execute a linear filter function at an output layer. The linear filter function may be an impulse response filter such as a linear finite impulse response filter. The linear filter function may process, augment and combine the intermediate layer outputs. The linear filter function may have a delay line intermediate layer output, and may iteratively sample the components. Processed output components are augmented with an element of a second set of weight factors (e.g., filter weights) and linearly combined. In some embodiments, the augmentation and linear combination may be executed through mathematical and/or logical operations. The augmentation may be a multiplication of one or more weight factors with a respective post-sampling, intermediate layer output. The linear combination may result in the summation of the augmented, post-sampling, intermediate layer outputs. In some embodiments, multiplication of weight factors with the intermediate layer outputs may occur during the summation such that a weight factor is multiplied by a post-sampling, intermediate layer output at subsequent iterations of the summation. The linear combination of the augmented, post-sampling, intermediate layer outputs may be an estimated nonlinear interference, which may be cancelled from a received signal.

FIG. 9 illustrates a method 900 for training weight factors for use in a minimum mean squares interference filter (e.g., 400 in FIG. 4) in a multi-technology wireless communications device in accordance with various embodiments 1-9, the method 900 may be executed in a computing device (e.g., 110, 120, 200) using software, general purpose or dedicated hardware, or a combination of software and hardware, such as the general purpose processor 206, baseband processor 216, or the like. In block 902, the multi-technology communication device may select the weight factors for augmenting the aggressor kernels and the second set of weight factors for use in the linear filter function. As described, in various embodiments, the weight factors may be determined at runtime, preprogrammed, and/or trained. In some embodiments the weight factors may be trained using a series of mathematical operations in which the first weight factors are determined using an initial estimate of the second set of weight factors, and the actual second set of weight factors is trained using the first set of weight factors and a second set of mathematical operations.

In block 904, the multi-technology communication device may determine an error present in the estimate of the nonlinear interference. Various known methods for determining the error of a function may be used to determine the error in block 904. In some embodiments, the error calculation may be for the mean square error of the estimated nonlinear interference compared with the nonlinear interference signal caused by the aggressor signal(s).

In determination block 906, the multi-technology communication device may determine whether the estimation of the nonlinear interference is complete. Estimation of the nonlinear interference may be considered to be complete at such time as the minimum mean squares interference filter has finished execution and an estimated nonlinear interference signal has been obtained (i.e., the real and imaginary estimated nonlinear interference have been combined). In response to determining that the estimation of the nonlinear interference is incomplete (i.e., determination block 906=“No”), the multi-technology communication device may train the weight factors in block 908. In various embodiments, the weight factors may be trained using a variety of optimization algorithms, for example a three stage minimum mean squares, gradient decent, the Gauss-Newton algorithm, and the Levenberg-Marquardt algorithm. Training of the weight factors may be regressively executed to further reduce the error of the estimated nonlinear interference. The multi-technology communication device may continue selecting weight factors for augmenting the aggressor kernels in block 902. Selection may include the newly trained weight factors.

In response to determining that the estimation of the nonlinear interference is complete (i.e., determination block 906=“Yes”), the multi-technology communication device may determine whether the nonlinear interference cancellation exceeds an efficiency threshold in determination block 910. The determination of whether the nonlinear interference cancellation exceeds the efficiency threshold may be a measure of whether the nonlinear interference is cancelled sufficient to enable the multi-technology communication device to decode and use the victim signal. The efficiency threshold may be a precalculated or predetermined value based on historical observations of a level of accuracy present in an estimated nonlinear interference signal that is necessary to enable proper decoding of a victim signal. In some embodiments, the efficiency threshold may be based on the error value determination of the nonlinear interference in block 904, in which the error level may be compared to an acceptable error level. In some embodiments, the efficiency threshold may be based on a success rate for decoding and using the victim signal. In response to determining that the nonlinear interference cancellation does not exceed the efficiency threshold (i.e., determination block 910=“No”), the multi-technology communication device may continue to train the weight factors in block 908. Training the weight factors may reduce the amount of error in the estimated nonlinear interference so that the cancellation of the estimated nonlinear interference may result in greater success of decoding and using the victim signal.

In response to determining that the nonlinear interference cancellation does exceed the efficiency threshold (i.e., determination block 910=“Yes”), the multi-technology communication device may reuse the weight factors for subsequent estimation and cancellation of nonlinear interference in block 912. As described, the multi-technology communication device may not always train the weight factors when estimating the nonlinear interference. The nonlinear interference caused by the one or more aggressor signals may vary by different amounts under various conditions. In some embodiments, the variation in the nonlinear interference may be small enough that the previously trained weight factors may result in a sufficiently accurate estimated nonlinear interference that further training is unnecessary. Determining when to train the weight factors or reuse the weight factors may be based on one or more criteria, including time, measurements of the aggressor signal(s), victim signal quality, and nonlinear interference noise cancellation efficiency, for example including error of the estimated nonlinear interference and/or success of decoding and using the victim signal.

In some embodiments, the method 900 may be executed at various times before, during, or after the execution of the method 700 and the method 800. For example, the method 900 may be executed to calculate at least some of the weight factors before they are used in active interference filtering. In some embodiments, certain blocks of the method 900 the method may not execute contiguously, but may instead execute interspersed with the blocks of the methods 700, 800.

In other words, the methods of various embodiments may manage interference, such as signal interference (e.g., non-linear interference), that is received in a multi-technology communication device. Managing or analyzing interference may include filtering a received aggressor signal using a minimum mean squares interference filter, or filtering construct. The minimum mean squares interference filter may include a number of layers (input layer, intermediate layer, output layer, etc.), in which different mathematical operations are executed, thereby extracting a numerical representation of estimated interference from the received aggressor signal. The multi-technology communication device may receive an aggressor signal (i.e., a signal interfering with or impeding another received signal) at an input layer of the minimum mean squares interference filter. The multi-technology communication device may generate a set of minimum mean squares (MMS) kernels, which may contain both real and imaginary elements, or components (i.e., elements represented by real numbers and elements represented by imaginary numbers). The multi-technology communication device may augment the MMS kernels with weight factors (weights, weighting components) at an intermediate layer of the minimum mean squares interference filter to produce augmented or combined MMS kernels. Augmentation may include multiplying each result of the radial basis function execution by a corresponding weight element (i.e., a multiplier). The multi-technology communication device may also linearly combine, sum, or add, the augmented MMS kernels at the intermediate layer to produce intermediate layer outputs. The multi-technology communication device may execute a linear filter function, FIR filter, finite impulse response filter, or Hammerstein structure on both the intermediate layer outputs at an output layer of the minimum mean squares interference filter to obtain estimated nonlinear interference. A result of the filtering/extracting may be an estimated interference (estimated nonlinear interference, estimated interference signal) that may be subtracted from the received victim signal (i.e., the signal subject to interference by the aggressor signal) to produce a mathematical representation of the intended received signal.

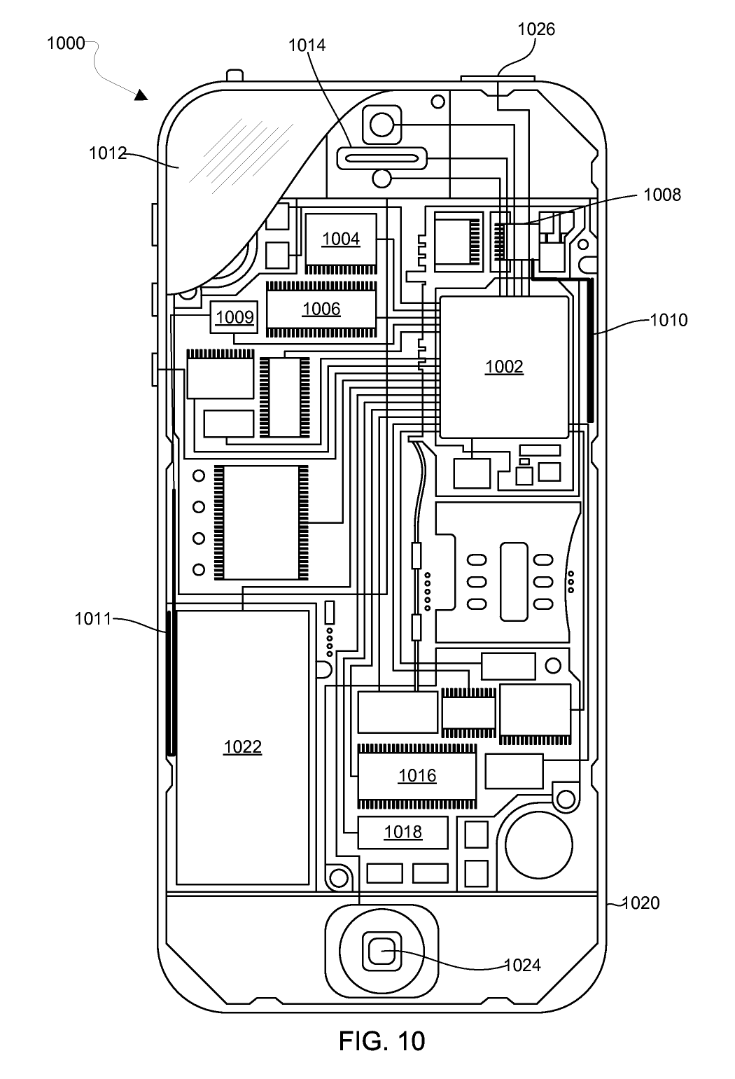

FIG. 10 illustrates an exemplary multi-technology communication device 1000 suitable for use with the various embodiments. The multi-technology communication device 1000 may be similar to the multi-technology device 110, 120, 200 (e.g., FIGS. 1 and 2). With reference to FIGS. 1-10, the multi-technology communication device 1000 may include a processor 1002 coupled to a touchscreen controller 1004 and an internal memory 1006. The processor 1002 may be one or more multicore integrated circuits designated for general or specific processing tasks. The internal memory 1006 may be volatile or non-volatile memory, and may also be secure and/or encrypted memory, or unsecure and/or unencrypted memory, or any combination thereof. The touchscreen controller 1004 and the processor 1002 may also be coupled to a touchscreen panel 1012, such as a resistive-sensing touchscreen, capacitive-sensing touchscreen, infrared sensing touchscreen, etc. Additionally, the display of the multi-technology communication device 1000 need not have touch screen capability.

The multi-technology communication device 1000 may have two or more cellular network transceivers 1008, 1009 coupled to antennae 1010, 1011, for sending and receiving communications via a cellular communication network. The combination of the transceiver 1008 or 1009 and the associated antenna 1010 or 1011, and associated components, is referred to herein as a radio frequency (RF) chain. The cellular network transceivers 1008, 1009 may be coupled to the processor 1002, which is configured with processor-executable instructions to perform operations of the embodiment methods described above. The cellular network transceivers 1008, 1009 and antennae 1010, 1011 may be used with the above-mentioned circuitry to implement the various wireless transmission protocol stacks and interfaces. The multi-technology communication device 1000 may include one or more cellular network wireless modem chips 1016 coupled to the processor and the cellular network transceivers 1008, 1009 and configured to enable communication via cellular communication networks.

The multi-technology communication device 1000 may include a peripheral device connection interface 1018 coupled to the processor 1002. The peripheral device connection interface 1018 may be singularly configured to accept one type of connection, or may be configured to accept various types of physical and communication connections, common or proprietary, such as USB, FireWire, Thunderbolt, or PCIe. The peripheral device connection interface 1018 may also be coupled to a similarly configured peripheral device connection port (not shown).

The multi-technology communication device 1000 may also include speakers 1014 for providing audio outputs. The multi-technology communication device 1000 may also include a housing 1020, constructed of a plastic, metal, or a combination of materials, for containing all or some of the components discussed herein. The multi-technology communication device 1000 may include a power source 1022 coupled to the processor 1002, such as a disposable or rechargeable battery. The rechargeable battery may also be coupled to the peripheral device connection port to receive a charging current from a source external to the multi-technology communication device 1000. The multi-technology communication device 1000 may also include a physical button 1024 for receiving user inputs. The multi-technology communication device 1000 may also include a power button 1026 for turning the multi-technology communication device 1000 on and off.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present claims.

The hardware used to implement the various illustrative logics, logical blocks, modules, and circuits described in connection with the various embodiments may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the present claims. Various modifications to these embodiments will be readily apparent to those skilled in the art, and the generic principles defined herein may be applied to other embodiments without departing from the scope of the claims. Thus, the present invention is not intended to be limited to the embodiments shown herein but is to be accorded the widest scope consistent with the following claims and the principles and novel features disclosed herein.

What is claimed is:

1. A method for managing signal interference in a multi-technology communication device, comprising:
receiving an aggressor signal at an input layer of a minimum mean squares interference filter;
generating a set of minimum mean squares kernels (MMS kernels);
augmenting the set of MMS kernels with weight factors at an intermediate layer of the minimum mean squares interference filter to produce augmented MMS kernels;
linearly combining the augmented MMS kernels at the intermediate layer to produce an intermediate layer output; and
executing a linear filter function on the intermediate layer output at an output layer of the minimum mean squares interference filter to obtain estimated nonlinear interference.

2. The method of claim 1, further comprising:
determining an error of the estimated nonlinear interference;
determining whether the error of the estimated nonlinear interference exceeds an efficiency threshold; and
cancelling the estimated nonlinear interference from a victim signal.

3. The method of claim 2, further comprising training the weight factors to reduce the error of the estimated nonlinear interference.

4. The method of claim 3, wherein:
training the weight factors to reduce the error of the estimated nonlinear interference comprises training the weight factors in response to determining that the error of the estimated nonlinear interference exceeds the efficiency threshold, and
cancelling the estimated nonlinear interference from the victim signal comprises cancelling the estimated nonlinear interference from the victim signal in response to determining that the error of the estimated nonlinear interference does not exceed the efficiency threshold.

5. The method of claim 3, further comprising training the weight factors using a three stage minimum mean squares method.

6. The method of claim 1, further comprising estimating an initial value of the weight factors using a three stage minimum mean squares method.

7. The method of claim 1, wherein the linear filter function is a finite impulse response filter.

8. The method of claim 1, wherein the linear filter function has a Hammerstein structure.

9. The method of claim 1, wherein the aggressor signal represents the aggressor signal received by an antenna of the multi-technology communication device at a specific instance in time.

10. The method of claim 1, wherein generating the set of MMS kernels comprises executing a kernel function on the aggressor signal to obtain the set of MMS kernels.

11. The method of claim 10, further comprising executing the kernel function from order 1 to order “p”.

12. The method of claim 1, further comprising cancelling the estimated nonlinear interference from a victim signal.

13. The method of claim 12, further comprising decoding the victim signal after cancelling the estimated nonlinear interference from the victim signal.

14. The method of claim 1, further comprising training a set of second weight factors using a three stage minimum mean squares method.

15. A method for managing signal interference in a multi-technology communication device, comprising:
receiving an aggressor signal at an input layer of a minimum mean squares interference filter;
generating a set of minimum mean squares kernels (MMS kernels); and
executing a linear filter function on the set of MMS kernels at an output layer of the minimum mean squares interference filter to obtain an estimated nonlinear interference.

16. The method of claim 15, further comprising:
determining an error of the estimated nonlinear interference;
determining whether the error of the estimated nonlinear interference exceeds an efficiency threshold; and
cancelling the estimated nonlinear interference from a victim.

17. The method of claim 15, wherein executing the linear filter function on the set of MMS kernels at the output layer of the minimum mean squares interference filter further comprises:
executing a separate sampling delay line on each MMS kernel within the set of MMS kernels to produce sampled MMS kernels;
augmenting the sampled MMS kernels with weight factors to produce augmented MMS kernels; and
linearly combining the augmented MMS kernels to produce the estimated nonlinear interference.

18. The method of claim 15, wherein the linear filter function is a finite impulse response filter.

19. The method of claim 15, wherein the linear filter function has a Hammerstein structure.

20. The method of claim 15, wherein the aggressor signal represents the aggressor signal received by an antenna of the multi-technology communication device at a specific instance in time.

21. The method of claim 15, wherein generating the set of MMS kernels comprises executing a kernel function on the aggressor signal to obtain the set of MMS kernels.

22. The method of claim 21, further comprising executing the kernel function from order 1 to order “p”.

23. The method of claim 15, further comprising cancelling the estimated nonlinear interference from a victim signal.

24. The method of claim 23, further comprising decoding the victim signal after cancelling the estimated nonlinear interference from the victim signal.

25. A mobile communications device, comprising:
an antenna;
a processor configured with processor-executable instructions to:
receive an aggressor signal at an input layer of a minimum mean squares interference filter;
generate a set of minimum mean squares kernels (MMS kernels);
augment the set of MMS kernels with weight factors at an intermediate layer of the minimum mean squares interference filter to produce augmented MMS kernels;
linearly combine the augmented MMS kernels at the intermediate layer to produce an intermediate layer output; and
execute a linear filter function on the intermediate layer output at an output layer of the minimum mean squares interference filter to obtain estimated nonlinear interference.

26. The mobile communications device of claim 25, wherein the processor is further configured with processor-executable instructions to cancel the estimated nonlinear interference from a victim signal received by the antenna.

27. The mobile communications device of claim 26, wherein the processor is further configured with processor-executable instructions to decode the victim signal after cancelling the estimated nonlinear interference from the victim signal.

28. A mobile communications device, comprising:
an antenna;
a processor configured with instructions to:
receive an aggressor signal at an input layer of a minimum mean squares interference filter;
generate a set of minimum mean squares kernels (MMS kernels);
execute a linear filter function on the set of MMS kernels at an output layer of the minimum mean squares interference filter to obtain an estimated nonlinear interference.

29. The mobile communications device of claim 28, wherein the processor is further configured with processor-executable instructions to execute the linear filter function on the set of MMS kernels at the output layer of the minimum mean squares interference filter by:
executing a separate sampling delay line on each MMS kernel of the set of MMS kernels to produce sampled MMS kernels;
augmenting the sampled MMS kernels with weight factors to produce augmented MMS kernels; and
linearly combining the augmented MMS kernels to produce the estimated nonlinear interference.
